(19) United States
(12) Patent Application Publication
(10) Pub. No.: US 2026/0140605 A1
(43) Pub. Date: May 21, 2026

(54) ELECTRONIC DEVICE AND METHOD FOR USING LOG INFORMATION TO DISPLAY TEXT OBJECT INDICATING STATE OF AVATAR, AND COMPUTER-READABLE STORAGE MEDIUM

(71) Applicant: NCSOFT Corporation, Seoul (KR)

(72) Inventors: Boyun KANG, Seongnam-si (KR); Kyeongdae KIM, Seongnam-si (KR); Munsu KIM, Seongnam-si (KR); Taeeun KIM, Seongnam-si (KR); Junghyun LEE, Seongnam-si (KR); Joowon LEE, Seongnam-si (KR); Sunggoo HEO, Seongnam-si (KR)

(73) Assignee: NCSOFT Corporation, Seoul (KR)

(21) Appl. No.: 19/451,271

(22) Filed: Jan. 16, 2026

Related U.S. Application Data
(63) Continuation of application No. PCT/KR2023/012307, filed on Aug. 18, 2023.

(51) Int. Cl. G06F 3/0482; A63F 13/58; G06F 3/04817; G06T 11/60

(52) U.S. Cl. CPC G06F 3/0482; A63F 13/58; G06T 11/60; G06F 3/04817; G06T 2200/24

(57) ABSTRACT

There is provided an electronic device and method thereof configured to display, on a display, multimedia content including a plurality of avatars. A processor of the device is configured to receive, from an external electronic device and by using a communication circuit, log information related to an event that has occurred in the multimedia content. The processor is configured to use the log information to identify the state of, among the plurality of avatars, a second avatar distinguished from a first avatar corresponding to the electronic device. The processor is configured to use the log information to display a text object, indicating the state of the second avatar, adjacent to a visual object corresponding to the second avatar in the multimedia content.

### CROSS-REFERENCE TO RELATED APPLICATION

This application is a continuation of International Application No. PCT/KR 2023/012307, filed on Aug. 18, 2023 the disclosure of which is incorporated by reference herein in its entirety.

### BACKGROUND

### 1. Field

Embodiments disclosed in this document relate to an electronic device, a method and a computer-readable storage medium to display a text object representing a state of an avatar using log information.

### 2. Description of Related Art

An electronic device may receive log information of avatars corresponding to a plurality of external electronic devices through a server. The electronic device may display, using the log information, on a display, a text for displaying a state of an avatar corresponding to each of users corresponding to the plurality of external electronic devices.

According to an embodiment, an electronic device may receive log information representing a change in a state of another avatar distinct from an avatar corresponding to the electronic device from an external electronic device. The electronic device may be required to visualize the state of the other avatar, based on displaying, on a display, a text object corresponding to the state of the other avatar using the log information.

The technical problems to be achieved in this document are not limited to those described above, and other technical problems not mentioned herein will be clearly understood by those having ordinary knowledge in the art to which the present invention belongs, from the following description.

summary There is provided electronic device including: a display; memory; communication circuitry; and a processor; wherein the processor is configured to: display, on the display, a multimedia content including a plurality of avatars; receive, using the communication circuitry, from an external electronic device, log information indicating an event occurring in the multimedia content; identify, using the log information and from among the plurality of avatars, a state of a second avatar that is distinct from a first avatar corresponding to the electronic device; and display, on the display and using the log information, a text object representing the state of the second avatar, adjacent to a visual object corresponding to the second avatar in the multimedia content.

The processor may be further configured to: display a user interface including one or more icons representing one or more functions performable using the first avatar in the multimedia content; based on receiving an input representing selecting the text object and from among the one or more functions, identify at least one icon corresponding to at least one function associated with the state of the second avatar; and display, on the display, a visual effect highlighting the at least one icon.

The processor may be further configured to: perform, using the first avatar and in response to another input indicating a selection of the at least one icon, the at least one function as indicating to change the state of the second avatar; based on performing the at least one function, receive, from the external electronic device, other log information, distinct from the log information, indicating the second avatar; and based on receiving the other log information, stop displaying the text object.

The processor may be further configured to: display, on the display and with the text object, another visual effect indicating that the at least one function, from among the one or more functions, as associated with the state of the second avatar may be included.

The processor may be further configured to: based on identifying the state of the second avatar, identify the at least one function as configured by another user interface and mapping each of a plurality of states, including the state of the second avatar, and the one or more functions.

The processor may be further configured to: based on receiving the log information, bypass displaying a text representing the log information by instead displaying the text object as a specified word representing the state of the second avatar.

The processor may be further configured to: perform, by controlling the first avatar and in response to an input indicating the text object, at least one function of changing the state of the second avatar to another state; based on performing the at least one function, receive, from the external electronic device, other log information, distinct from the log information, indicating the second avatar; and based on receiving the other log information, stop displaying the text object.

The processor may be further configured to: identify a relationship between the plurality of avatars included in at least one group; based on identifying the relationship between the plurality of avatars, receive, from the external electronic device, avatar information of the second avatar as corresponding to another external electronic device distinct from the external electronic device; and based on receiving the avatar information from the external electronic device, display, on the display, the visual object corresponding to the second avatar in the multimedia content.

There is provided a method performed by an electronic device, the method including: displaying, on a display, a multimedia content including a plurality of avatars; receiving, using communication circuitry, from an external electronic device, log information indicating an event occurring in the multimedia content; identifying, using the log information and from among the plurality of avatars, a state of a second avatar that may be distinct from a first avatar corresponding to the electronic device; and displaying, on the display and using the log information, a text object representing the state of the second avatar, adjacent to a visual object corresponding to the second avatar in the multimedia content.

The method may further include: displaying a user interface including one or more icons representing one or more functions performable using the first avatar in the multimedia content; based on receiving an input representing selecting the text object and from among the one or more functions, identifying at least one icon corresponding to at least one function associated with the state of the second avatar; and displaying, on the display, a visual effect highlighting the at least one icon.

The method may further include: performing, using the first avatar and in response to another input indicating a selection of the at least one icon, the at least one function as indicating to change the state of the second avatar; based on performing the at least one function, receiving, from the external electronic device, other log information, distinct from the log information, indicating the second avatar; and based on receiving the other log information, stopping displaying the text object.

The method may further include: displaying, on the display and with the text object, another visual effect indicating that the at least one function, from among the one or more functions, as associated with the state of the second avatar may be included.

The method may further include: based on identifying the state of the second avatar, identifying the at least one function as configured by another user interface and mapping each of a plurality of states, including the state of the second avatar, and the one or more functions.

The may further include: based on receiving the log information, bypassing displaying a text representing the log information by instead displaying the text object as a specified word representing the state of the second avatar.

The method may further include: performing, by controlling the first avatar and in response to an input indicating the text object, at least one function of changing the state of the second avatar to another state; based on performing the at least one function, receiving, from the external electronic device, other log information, distinct from the log information, indicating the second avatar; and based on receiving the other log information, stopping displaying the text object.

There is provided a non-transitory computer-readable storage medium storing one or more programs, wherein the one or more programs are configured to, when executed by a processor of an electronic device with a display, memory, and communication circuitry, cause the electronic device to: display, on the display, a multimedia content including a plurality of avatars; receive, using the communication circuitry, from an external electronic device, log information indicating an event occurring in the multimedia content; identify, using the log information and from among the plurality of avatars, a state of a second avatar that may be distinct from a first avatar corresponding to the electronic device; and display, on the display and using the log information, a text object representing the state of the second avatar, adjacent to a visual object corresponding to the second avatar in the multimedia content.

The one or more programs may be further configured to, when executed by the processor of the electronic device, cause the electronic device to: display a user interface including one or more icons representing one or more functions performable using the first avatar in the multimedia content; based on receiving an input representing selecting the text object and from among the one or more functions, identify at least one icon corresponding to at least one function associated with the state of the second avatar; and display, on the display, a visual effect highlighting the at least one icon.

The one or more programs may be further configured to, when executed by the processor of the electronic device, cause the electronic device to: perform, using the first avatar and based on another input indicating a selection of the at least one icon, the at least one function as indicating to change the state of the second avatar; based on performing the at least one function, receive, from the external electronic device, other log information, distinct from the log information, indicating the second avatar; and based on receiving the other log information, temporarily stop displaying the text object.

The one or more programs may be further configured to, when executed by the processor of the electronic device, cause the electronic device to: display, on the display and with the text object, another visual effect indicating that the at least one function, from among the one or more functions, as associated with the state of the second avatar may be included.

The one or more programs may be further configured to, when executed by the processor of the electronic device, cause the electronic device to: based on identifying the state of the second avatar, identify the at least one function as configured by another user interface and mapping each of a plurality of states, including the state of the second avatar, and the one or more functions.

According to an embodiment, using log information receiving log information representing a change in a state of another avatar distinct from an avatar corresponding to an electronic device from an external electronic device, the electronic device can visualize the state of the other avatar, based on displaying, on a display, a text object corresponding to the state of the other avatar.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is an exemplary block diagram of an electronic device in a network environment, according to one or more embodiments;

FIG. 2 illustrates an example of a state in which an electronic device visualizes a state of an avatar using log information, according to one or more embodiments;

FIG. 3 illustrates an example of a text object corresponding to a state of an avatar displayed adjacent to a visual object representing the avatar by an electronic device, according to one or more embodiments;

FIG. 4 illustrates an example of a state in which a plurality of electronic devices in a network environment displays different screens, according to one or more embodiments;

FIG. 5 illustrates an example of an operation in which an electronic device recommends a skill corresponding to a text object, in response to an input on the text object, according to one or more embodiments;

FIG. 6 illustrates an example of an operation in which an electronic device controls an avatar based on a skill corresponding to a text object, in response to an input on the text object, according to one or more embodiments;

FIG. 7 illustrates an example of a state in which an electronic device displays, using log information, a plurality of text objects representing a state of an avatar, according to one or more embodiments; and

FIG. 8 illustrates an example of a flowchart representing an operation of an electronic device, according to one or more embodiments.

### DETAILED DESCRIPTION

The electronic device (or the external electronic device) according to various embodiments may be one of various types of electronic devices. The electronic devices may include, for example, a portable communication device (e.g., a smartphone), a computer device, a portable multimedia device, a portable medical device, a camera, a wearable device, a server, or a home appliance. According to one or more embodiments of the disclosure, the electronic devices (or the external electronic device) are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with the present document, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software (e.g., the program) including one or more instructions that are stored in a storage medium that is readable by a machine (e.g., the electronic device 101). For example, a processor of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or AppStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Hereinafter, various embodiments of the present document will be described with reference to an accompanying drawing.

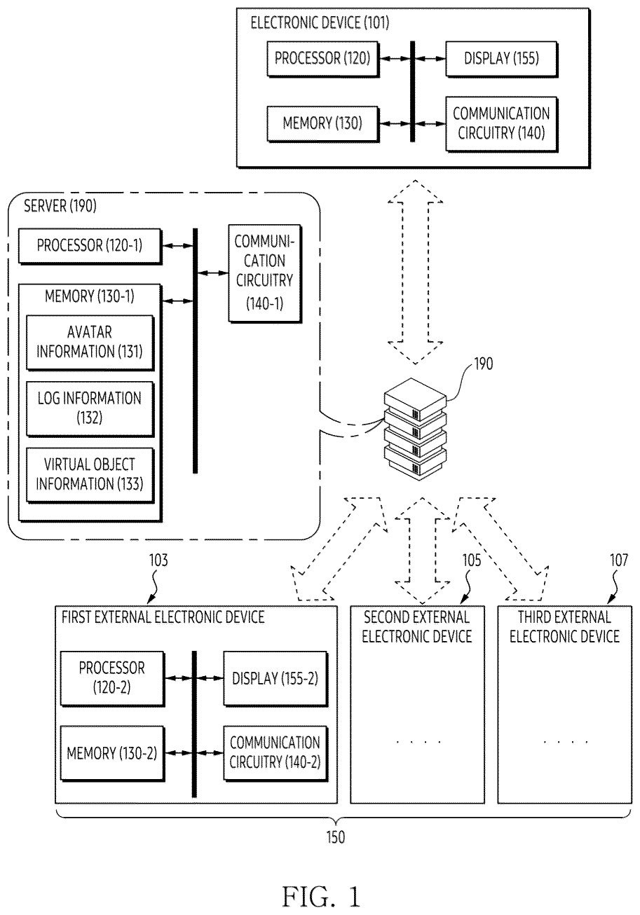

FIG. 1 is an exemplary block diagram of an electronic device in a network environment, according to one or more embodiments.

Referring to FIG. 1, an environment illustrated in FIG. 1 may include an electronic device 101, a plurality of external electronic devices 150, and a server 190. The electronic device 101 may be connected to the plurality of external electronic devices 150 based on a wired network and/or a wireless network. For example, the wired network may include Internet, a local area network (LAN), a wide area network (WAN), Ethernet, or a network such as a combination thereof. The wireless network may include long term evolution (LTE), 5g new radio (NR), wireless fidelity (WiFi), Zigbee, near field communication (NFC), Bluetooth, bluetooth low-energy (BLE), or a network such as a combination thereof. In FIG. 1, it is illustrated that the electronic device 101 is directly connected to the plurality of external electronic devices 150 through the server 190, but is not limited thereto. For example, the electronic devices 101 and the plurality of external electronic devices 150 may be indirectly connected through one or more routers and/or one or more access points (APs).

According to one or more embodiments, the server 190 may mean a server of a service provider. For example, the server 190 may register users of the electronic device 101 and the plurality of external electronic devices 150, which are client devices, based on linkage with a database that storing user information subscribed to a service (e.g., a multimedia content service or a game service), or perform user authentication based at least on an association between account information received from at least one (e.g., the electronic device 101) of the electronic devices 101 and the plurality of external electronic devices 150 and account information stored in the database storing the user information. For example, the service may include the game service provided to users who subscribe to the service. The service may include a program, an application, and/or a library for providing the game service.

According to one or more embodiments, the electronic device 101 may process a calculation request associated with a software application received from the plurality of external electronic devices 150, which are the client devices, and transmit information on a result of the process to the server 190, based on linkage with a database (e.g., memory 130-1 of the server 190) storing data for execution of a service-related software application (e.g., a game software application). The calculation request associated with the application received from the plurality of external electronic devices 150 may include avatar information corresponding to each account information of the users.

Referring to FIG. 1, according to one or more embodiments, the electronic devices 101 may include a personal computer (PC) such as a laptop or a desktop, a smartphone, a smartpad, a tablet PC, a smartwatch, and a smart accessory such as a head-mounted device (HMD). For example, the electronic device 101 may include at least one of a processor 120, memory 130, or communication circuitry 140. The processor 120, the memory 130, the communication circuitry 140 may be electronically and/or operably coupled with each other by an electronic component such as a communication bus. A type and/or the number of hardware components included in the electronic device 101 are not limited as illustrated in FIG. 1. For example, the electronic device 101 may include only some of hardware components illustrated in FIG. 1.

According to one or more embodiments, the processor 120 of the electronic device 101 may include a hardware component for processing data based on one or more instructions. For example, the hardware component for processing the data may include an arithmetic and logic unit (ALU), a field programmable gate array (FPGA), and/or a central processing unit (CPU). The number of the processors 120 may be one or more. For example, the processor 120 may have a structure of a multi-core processor such as a dual core, a quad core, or a hexa core.

According to one or more embodiments, the memory 130 of the electronic device 101 may include a hardware component for storing data and/or an instruction inputted to and/or outputted from the processor 210. For example, the memory 130 may include volatile memory such as random-access memory (RAM), and/or non-volatile memory such as read-only memory (ROM). For example, the volatile memory may include at least one of dynamic RAM (DRAM), static RAM (SRAM), Cache RAM, and pseudo SRAM (PSRAM). For example, the non-volatile memory may include at least one of programmable ROM (PROM), erasable PROM (EPROM), electrically EPROM (EEPROM), flash memory, a hard disk, a compact disk, and an embedded multi media card (eMMC).

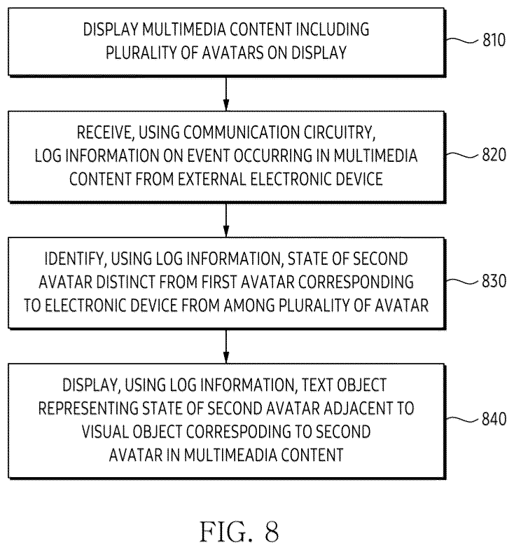

According to one or more embodiments, in the memory 130 of the electronic device 101, one or more instructions (or commands) representing a calculation and/or an operation to be performed by the processor 120 of the electronic device 101 on data may be stored. A set of one or more instructions may be referred to as firmware, an operating system, a process, a routine, a sub-routine and/or an application. For example, when a set of a plurality of instructions distributed in a form of the operating system, the firmware, a driver, and/or the application are executed, the electronic device 101 and/or the processor 120 may perform at least one of operations of FIG. 8. Hereinafter, an application being installed in the electronic device 101 may mean that one or more instructions provided in a form of the application are stored in the memory 130 of the electronic device 101, and the one or more applications are stored in an format (e.g., a file with an extension specified by an operating system of the electronic device 101) executable by the processor 120. As an example, an application may include a program associated with a service provided to the user, and/or a library.

According to one or more embodiments, the communication circuitry 140 of the electronic device 101 may include a hardware component for supporting transmission and/or reception of a signal between the electronic device 101 and the plurality of external electronic devices 150. For example, the communication circuitry 140 may include at least one of a modem (MODEM), an antenna, and an optic/electronic (O/E) converter. For example, the communication circuitry 140 may support transmission and/or reception of a signal based on a various type of protocol such as the ethernet, the LAN, WAN, the WiFi, the Bluetooth, the BLE, the ZigBee, the LTE, and the 5G NR.

According to one or more embodiments, a display 155 of the external electronic device 101 may be controlled by a controller such as the processor 120 and may output visualized information to the user. The display 155 may include a flat panel display (FPD), and/or electronic paper. The FPD may include a liquid crystal display (LCD), a plasma display panel (PDP), and/or one or more light emitting diodes (LEDs). The LED may include an organic LED (OLED). For example, the display 155 may be used to display an image obtained by the processor 120 or an image obtained by display driving circuitry. For example, the electronic device 101 may display an image on a portion of the display 155 under control of the display driving circuitry. However, it is not limited thereto. For example, the electronic device 101 may display a multimedia content including an avatar corresponding to the electronic device 101 on the display 155, based on receiving information on a multimedia content (e.g., a game screen) from the server 190.

For example, the server 190 may include at least one of a processor 120-1, the memory 130-1, and communication circuitry 140-1. A processor 120-2, memory 130-2, or communication circuitry 140-2 may be electronically and/or operably coupled with each other by an electronic component such as a communication bus. A type and/or the number of hardware components included in the server 190 are not limited as illustrated in FIG. 1. For example, the server 190 may include only some of hardware components illustrated in FIG. 1. For example, the processor 120-1 may correspond to the processor 120 of the electronic device 101. For example, the memory 130-1 may correspond to the memory 130 of the electronic device 101. The communication circuitry 140-1 may correspond to the communication circuitry 140-2 of the electronic device 101. To reduce repetition of a description, redundant descriptions may be omitted.

According to one or more embodiments, the server 190 may store account information of users subscribed to a service (e.g., a game service) based on the server 190 in the memory 130-1. For example, the account information of the users may include avatar information 131 corresponding to the account information in the game service. The account information of the users may include information on an electronic device owned by the users.

For example, the avatar information 131 may include stats, a level, a skill of the avatar and/or external appearance information of the avatar. For example, the avatar may include a playable character performing a specified action based on an input of the user associated with account information (or an electronic device) corresponding to the avatar. The server 190 may identify the input of the user, based on receiving at least one signal from at least one electronic device owned by the user of the electronic device 101 and/or the plurality of external electronic devices 150. The electronic device 101 and/or the server 190 may control the avatar, based on identifying the input of the user.

For example, while providing a service to the electronic device 101 and the plurality of external electronic devices 150, log information 132 may include data associated with communication software occurring between the electronic device 101 and the plurality of external electronic devices 150, or information obtained by logging an event occurring between a first avatar corresponding to the electronic device 101 and second avatars corresponding to the plurality of external electronic devices 150. For example, the event occurring between the first avatar and the second avatars may be identified, based on a state change, whether hit, whether attacked, a used skill, information on an attacked target, and information on a hit target of each of the first avatars or the second avatars. As an example, the first avatar and the second avatars may be included in at least one group (e.g., a party, or a clan). The server 190 may share the log information 132 occurring between the electronic device 101 and the plurality of external electronic devices 150, based on identifying the first avatar and the second avatars included in the at least one group.

For example, virtual object information 133 may include information on a non-playable character distinct from the first avatar corresponding to the electronic device 101 or the second avatars corresponding to the plurality of external electronic devices 150. The non-playable character may include a monster distinct from the first avatar and/or the second avatars. The monster may be an attack target by the first avatar and/or the second avatars. For example, information included in the server 190 is not limited to the above-described example. As an example, information on the multimedia content service provided by the server 190 such as map information or quest information of the a multimedia content may be further included.

According to one or more embodiments, the plurality of external electronic devices 150 may be owned by different users. For example, a first external electronic device 103, a second external electronic device 105, and/or a third external electronic device 107 may include a personal computer (PC) such as a laptop or a desktop, a smartphone, a smartpad, a tablet personal computer (PC), a smartwatch, and a smart accessory such as a HMD. For example, the plurality of external electronic devices 150 may be an example of an electronic device that receive the service (e.g., the game service) through the server 190. Each of users using the first external electronic device 103, the second external electronic device 105, and/or the third external electronic device 107 may be subscribers of the service provided by the electronic device 101.

According to one or more embodiments, the first external electronic device 103 from among the plurality of external electronic devices 150 may include at least one of the processor 120-2, the memory 130-2, the communication circuitry 140-2 and a display 155-2. The processor 120-2, the memory 130-2, the communication circuitry 140-2 and/or the display 155-2 may be electronically and/or operably coupled with each other by an electronic component such as a communication bus. A type and/or the number of hardware components included in the first electronic device 103 are not limited to as illustrated in FIG. 1. For example, the first external electronic device 103 may include only some of hardware components illustrated in FIG. 1. For example, the processor 120-2 may correspond to the processor 120 of the electronic device 101. For example, the memory 130-2 may correspond to the memory 130 of the electronic device 101. The communication circuitry 140-2 may correspond to the communication circuitry 140-2 of the electronic device 101. The display 155-2 may correspond to the display 155 of the electronic device 101. To reduce repetition of a description, redundant descriptions may be omitted.

According to one or more embodiments, each of the plurality of external electronic devices 150 (e.g., the second external electronic device 105, or the third external electronic device 103) may include at least a portion or all of a component included in the first external electronic device 103. Each of the plurality of external electronic devices 150 may be independently configured by including at least a portion or all of the component included in the first external electronic device 103.

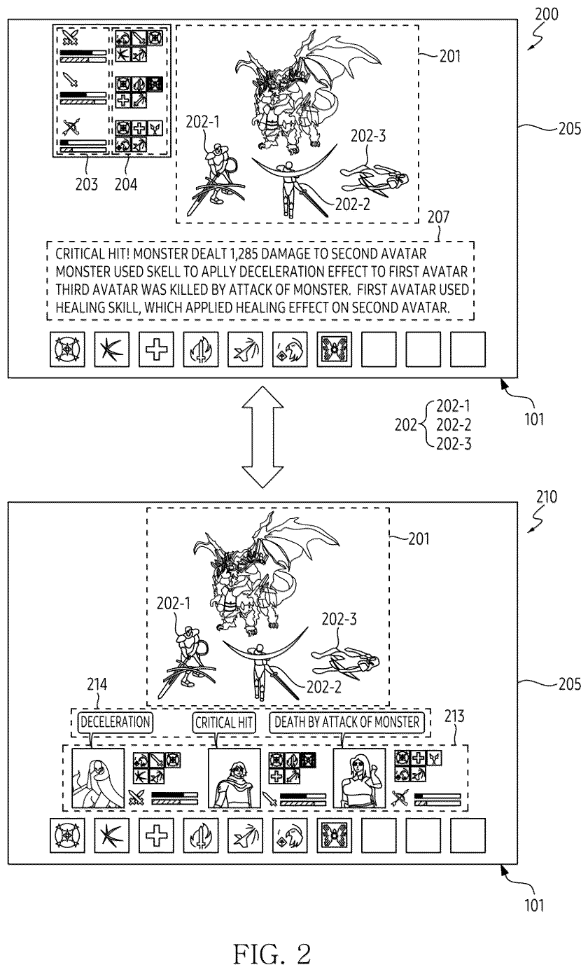

As described above, according to one or more embodiments, the electronic device 101 may receive the avatar information corresponding to the plurality of external electronic devices 150 through the server 190. Based on receiving the avatar information, the electronic device 101 may display an avatar corresponding to each of the plurality of external electronic devices 150 on a display. While displaying the avatar, the electronic device 101 may receive log information representing a change in a state of the avatar from the server 190. The electronic device 101 may display a text object representing the state of the avatar on the display, using the log information. The electronic device 101 may provide a simplified user interface, by displaying the text object representing the state of the avatar instead of displaying a text representing entire data included in the log information on the display. The electronic device 101 may provide the user with a user experience that may more easily perform an interaction with other users corresponding to the plurality of external electronic devices 150, by providing the simplified user interface, such as by relying on information obtained from the network and based on the internal processing of one of more of the various electronic devices described herein accessing one or more of their memories indicative of respective application usage as described herein for example. Hereinafter, one or more embodiments in which the electronic device 101 provides the simplified user interface using the log information will be described later with reference to FIG. 2.

FIG. 2 illustrates an example of a state in which an electronic device visualizes a state of an avatar using log information, according to one or more embodiments. Referring to FIG. 2, according to one or more embodiments, state 200 and state 210 in which an electronic device 101 displays a multimedia content 205 on a display are illustrated.

According to one or more embodiments, the electronic device 101 may transmit a signal for displaying a multimedia content to a server (e.g., the server 190 of FIG. 1). The electronic device 101 may display the multimedia content 205 on the display based on receiving information on the multimedia content 205 from the server. The signal for displaying the multimedia content may include a signal for accessing a service provided by the server.

For example, the electronic device 101 may display the multimedia content 205 on the display in the state 200. The multimedia content 205 may include avatars 202, one or more virtual objects (e.g., a monster, or an NPC), and/or one or more user interfaces for using the service provided by the server. For example, the multimedia content 205 may include a first avatar 202-1 corresponding to the electronic device 101, a second avatar 202-2 (or a third avatar 202-3) corresponding to at least one of a plurality of external electronic devices (e.g., the plurality of external electronic devices 150 of FIG. 1), a visual object 203 representing the avatars 202, a visual object 204 representing a state of the avatars 202, a text 207 representing the state of the avatars 202, and/or an in-game screen 201. For example, the electronic device 101 may display the visual object 203 and the visual object 204 and/or the text 207 by overlapping at least a portion of the in-game screen 201. The in-game screen 201 may include the avatars 202 and/or one or more virtual objects. The electronic device 101 may control an avatar displayed in the in-game screen 201, based on an input of a user.

For example, the avatars 202 may be used in order for users of each of the electronic devices 101 and/or the plurality of external electronic devices, such as the first external electronic device 103, the second external electronic device 105, and the third external electronic device 107, to utilize the service provided by the server (e.g., the server 190 of FIG. 1). For example, the server may identify the avatars 202 representing each of the users, based on one or more account information corresponding to each of the users. As an example, the server may identify a relationship between the avatars 202 included in at least one group (e.g., a party, or a clan). Based on identifying the relationship between the avatars 202, the server may transmit information on the first avatar 202-1 and/or another avatar (e.g., the second avatar 202-2 or the third avatar 202-3) distinct from the first avatar 202-1 to the electronic device 101.

For example, the electronic device 101 may display the visual object 203 representing the avatars 202 on the display, based on receiving information (e.g., log information) on the avatars 202. The visual object 203 may include a name of each of the avatars 202, a job of each of the avatars 202, a hit point or a health point (HP) of the avatars 202, a magic point or a mana point (MP) of the avatars 202, and/or an external appearance of the avatars 202.

For example, the electronic device 101 may display the visual object 204 representing the state of the avatars 202 on the display, based on receiving the information on the avatars 202 from an external electronic device (e.g., the server). The visual object 204 may represent whether a skill for changing a stat of the avatars 202 is applied to the avatars 202. The visual object 204 may include an icon representing a buff skill for improving a stat of the avatars 202 applied to the avatars 202, and/or an icon representing a debuff skill for reducing a stat of the avatars 202 applied to the avatars 202. The visual object 204 may include an icon representing a skill that grants a specified effect (e.g., a special ability) to the avatars 200. However, it is not limited thereto.

For example, the electronic device 101 may receive log information logging an event occurring to the avatars 202 from the server in the in-game screen 201. The electronic device 101 may display the text 207 representing the log information on the display. The log information may include state information on a state of an avatar corresponding to each of the plurality of external electronic devices distinct from the electronic device 101. The log information may include a skill used using each of the avatars 202, an attack target, a hit target, a HP reduction rate, and/or state change information of the avatar.

According to one or more embodiments, the electronic device 101 may display the multimedia content 205 in the state 210. The multimedia content 205 may include a visual object 213 corresponding to the avatars 202, and/or the in-game screen 201. The visual object 213 may include the visual objects 203 and 204.

For example, in the state 210, the electronic device 101 may receive the information (e.g., the log information 132 of FIG. 1) from the server through communication circuitry. Based on receiving the log information, the electronic device 101 may identify, in the log information, identification information (e.g., a name of an avatar) of the avatar, and/or whether a state of the avatar is changed. The electronic device 101 may, based on receiving the log information, bypass displaying the text 207 representing the log information, and display a text object 214 representing the state of the avatar. The text object 214 may be obtained using a specified word representing the state of the avatar in the text 207. The electronic device 101 may, using the log information, display the text object 214 representing the state of the avatar adjacent to the visual object 213 corresponding to the avatar. The electronic device 101 may, based on displaying the text object 214, visualize an event occurring in the in-game screen 201.

As described above, since the event occurring in the in-game screen 201 may be more than or equal to one, the electronic device 101 may use the text object 214 to guide the user to more easily identify the event occurring in the in-game screen 201, using at least one word (e.g., a keyword) included in the text 207 representing the log information.

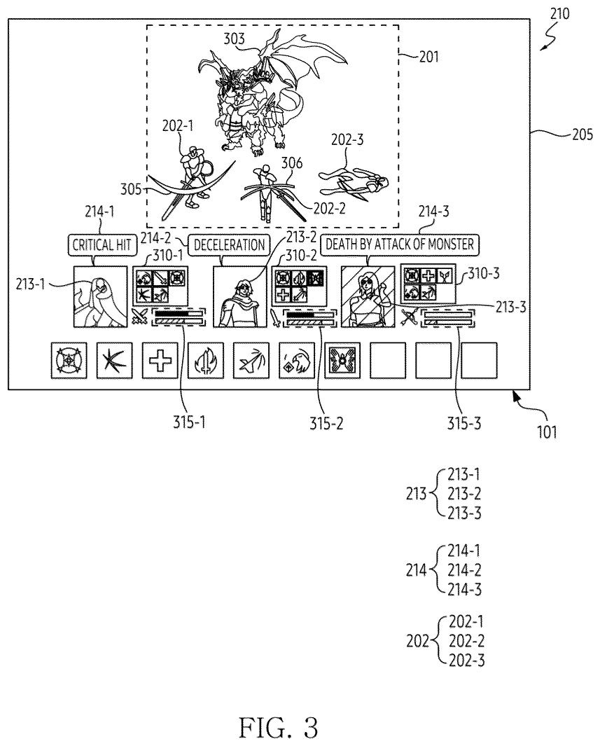

Hereinafter, referring to FIG. 3, an exemplary description of the text object 214 included in the multimedia content 205 displayed by the electronic device 101 in the state 210 will be described later.

FIG. 3 illustrates an example of a text object corresponding to a state of an avatar displayed adjacent to a visual object representing the avatar by an electronic device, according to one or more embodiments. Referring to FIG. 3, according to one or more embodiments, an example of a state 210 in which an electronic device 101 displays a multimedia content 205 including a text object 214 on a display is illustrated. The state 210 of FIG. 3 may be referred to the state 210 of FIG. 2.

According to one or more embodiments, the electronic device 101 may display the multimedia content 205 including avatars 202 on the display, in the state 210. The electronic device 101 may receive information for displaying the multimedia content 205 from a server (e.g., the server 190 of FIG. 1), based on a specified period. The electronic device 101 may receive, using communication circuitry, from the server, log information on a first avatar 202-1 corresponding to the electronic device 101 and/or a second avatar 202-2 (or a third avatar 202-3) distinct from the first avatar 202-1 from among the avatars 202.

For example, the electronic device 101 may display, based on receiving the log information on the first avatar 202-1, a visual object 213-1 corresponding to the first avatar 202-1 on the display. The electronic device 101 may display, based on receiving the log information on the first avatar 202-1, a text object 214-1 representing a state of the first avatar 202-1 adjacent to the visual object 213-1. As an example, the electronic device 101 may display the visual object 213-1 at a different position distinct from a position where the visual objects 213 of FIG. 2 are displayed to distinguish the first avatar 202-1 (or the visual object 213-1) corresponding to the electronic device 101 from other avatars (e.g., the second avatar 202-2 or the third avatar 202-3). However, it is not limited thereto.

For example, the electronic device 101 may identify, based on the log information, an event representing a hit 305 for the first avatar 202-1. For example, the event representing the hit 305 may include an event in which a hit point (HP) greater than or equal to a specified threshold is reduced. The electronic device 101 may display, based on identifying the event, the text object 214-1 (e.g., a critical hit) representing a reduction rate of a specified HP adjacent to the visual object 213-1. The electronic device 101 may change, based on identifying the event, a visual object 315-1. For example, visual objects, such as the visual object 315-1, the visual object 315-2, and the visual object 315-3, may represent a hit point (HP) and/or a mana point (MP) of avatars. The electronic device 101 may change, based on the reduction rate of the specified HP, at least a portion of the visual object 315-1 corresponding to the first avatar 202-1 from among the visual objects, such as the visual object 315-1, the visual object 315-2, and the visual object 315-3.

For example, the electronic device 101 may display, based on receiving log information on the second avatar 202-2, a visual object 213-2 corresponding to the second avatar 202-2 on the display. For example, the electronic device 101 may display, using the log information on the second avatar 202-2, a text object 214-2 representing a state (e.g., deceleration) of the second avatar 202-2 adjacent to the visual object 213-2 corresponding to the second avatar 202-2 in the multimedia content 205. The text object 214-2 may represent a change in a stat of the second avatar. For example, the electronic device 101 may identify an event that causes the stat (or the state) of the second avatar 202-2 to be changed. The electronic device 101 may receive, from the server, log information representing a state of the second avatar 202-2 to which a skill 306 for decreasing a moving speed is applied. The electronic device 101 may display, based on receiving the log information, the text object 214-2 representing a decrease in the moving speed on the display adjacent to the visual object 213-2 corresponding to the second avatar 202-2.

For example, the electronic device 101 may display a visual object 213-3 corresponding to the third avatar 202-3 included in at least one group on the display. The electronic device 101 may display, using log information on the third avatar 202-3, a text object 214-3 representing a state (e.g., death) of the third avatar 202-3 adjacent to the visual object 213-3 corresponding to the third avatar 202-3 in the multimedia content 205. The text object 214-3 may represent information for identifying a hit target and whether the third avatar 202-3 survives. The visual object 213-3 may be displayed based on a color different from the visual object 213-1 and the visual object 213-2, based on death of the third avatar 202-3.

For example, the electronic device 101 may display, on the display, visual objects, such as the visual object 310-1, the visual object 310-2, and the visual object 310-3, representing a skill effect applied to each of the avatars 202 adjacent to the visual objects 213. For example, skills corresponding to each of the visual objects, such as the visual object 310-1, the visual object 310-2, and the visual object 310-3, may cause a beneficial effect (e.g., increased attack speed) to each of the avatars 202. At least a portion of the skills corresponding to each of the visual objects, such as the visual object 310-1, the visual object 310-2, and the visual object 310-3, 3 may include skills (e.g., the decrease in the moving speed) that cause an adverse effect to each of the avatars 202. For example, the electronic device 101 may display the text objects 214 at a position spaced apart from the visual objects, such as the visual object 315-1, the visual object 315-2, and the visual object 315-3,. However, it is not limited thereto.

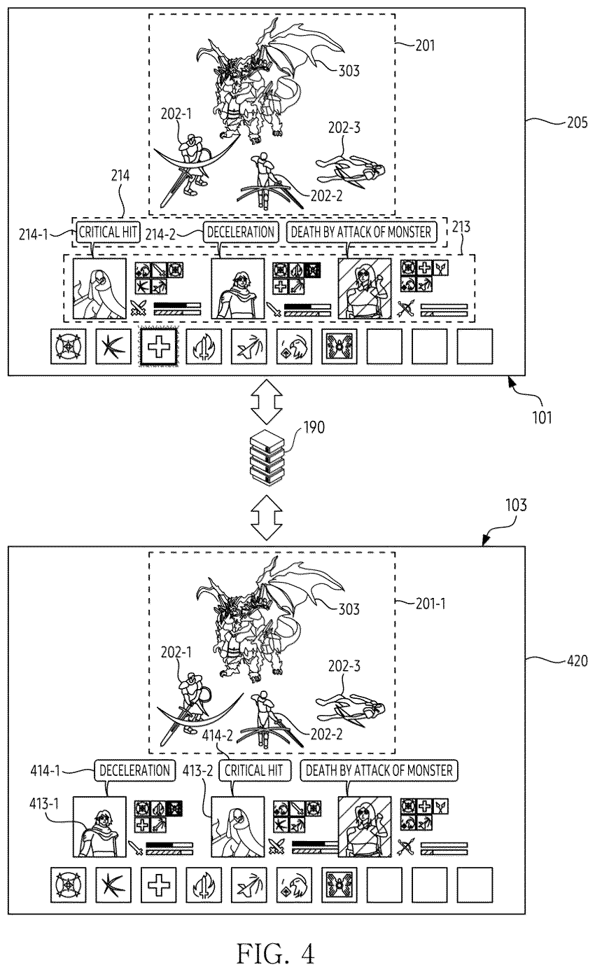

For example, the electronic device 101 may identify an event in which the first avatar 202-1 is hit from a virtual object 303 included in an in-game screen 201. The electronic device 101 may transmit, based on identifying the event, information on the event to the server. The server may transmit the log information representing the event to a plurality of external electronic devices 150. As an example, the plurality of external electronic devices 150 may display a text object representing the event adjacent to a visual object corresponding to the first avatar 202-1. An operation in which at least one of the plurality of external electronic devices 150 displays the text object representing the event adjacent to the visual object corresponding to the first avatar 202-1 will be described later with reference to FIG. 4.

As described above, according to one or more embodiments, the electronic device 101 may provide, based on receiving log information from the server, an environment in which the user may focus more on the in-game screen 201 by displaying the text objects 214 in which a text is simplified instead of displaying the text (e.g., the text 207 of FIG. 2) representing the log information on the display.

FIG. 4 illustrates an example of a state in which a plurality of electronic devices in a network environment displays different screens, according to one or more embodiments. An electronic device 101 of FIG. 4 may include the electronic device 101 of FIG. 1, FIG. 2, and FIG. 3.

Referring to FIG. 4, according to one or more embodiments, an exemplary network environment in which the electronic device 101 and a first external electronic device 103 from among a plurality of external electronic devices display a multimedia content 420 is illustrated. For example, the electronic device 101 may display a multimedia content 205 on a display (e.g., the display 155 of FIG. 1). A first avatar 202-1 corresponding to the electronic device 101 and a second avatar 202-2 corresponding to the first external electronic device 103 may be included in at least one group. A server 190 may transmit, based on identifying the first avatar 202-1 and the second avatar 202-2 included in the at least one group, log information recording an event occurring in an in-game screen to the electronic device 101 and the first external electronic device 103.

According to one or more embodiments, the electronic device 101 may identify an event representing that the first avatar 202-1 is hit by a virtual object 303 in an in-game screen 201. The event may represent a case that a HP reduction rate of the first avatar is greater than or equal to a specified threshold. The electronic device 101 may transmit, based on identifying the event, a signal representing the event to the server 190. The server 190 may store, based on receiving the signal, log information representing that the first avatar 202-1 corresponding to the electronic device 101 is hit by a virtual object (e.g., the virtual object 303 of FIG. 3) in memory of the server 190. The server 190 may transmit the log information to the first external electronic device 103.

For example, the first external electronic device 103 may display the multimedia content 420 on a display (e.g., the display 155-2 of FIG. 1) of the first external electronic device 103. The multimedia content 205 displayed by the electronic device 101 and the multimedia content 420 displayed by the first external electronic device 103 may be similar. At least a portion of the in-game screen 201 displayed by the electronic device 101 and at least a portion of an in-game screen 201-1 displayed by the first external electronic device 103 may be similar. The electronic device 101 and the first external electronic device 103 may render a multimedia content, based on receiving substantially similar map information and/or virtual object information from a server.

For example, the first external electronic device 103 may display a visual object 413-1 corresponding to the second avatar (e.g., the second avatar 202-2 of FIG. 2) on the display of the first external electronic device 103. In terms of the second avatar corresponding to the first external electronic device, a position at which the first external electronic device 103 displays the visual object 413-1 may correspond a position at which the electronic device 101 displays a visual object 213-1 in a state (e.g., the state 210 of FIG. 3). However, it is not limited thereto.

For example, the first external electronic device 103 may display a visual object 413-2 corresponding to the first avatar 202-1 on the display of the first external electronic device 103. The first external electronic device 103 may receive log information on the first avatar from the server 190. The log information may include information representing an event representing that the first avatar 202-1 is hit by the virtual object 303. The first external electronic device 103 may identify, based on receiving the log information on the first avatar, a change in a state of the first avatar. The first external electronic device 103 may identify a text to be displayed as a text object from among texts representing the change in the state of the first avatar. The first external electronic device 103 may display a text object 414-2 representing the identified text (e.g., a critical hit) adjacent to the visual object 413-2.

For example, the electronic device 101 may display a text object 214-2 representing a state of the second avatar on the display based on receiving log information on the second avatar 202-2 corresponding to the first external electronic device 103 from the server, and the first external electronic device 103 may display the text object 414-2 representing the state of the first avatar on the display based on receiving the log information on the first avatar 202-1 corresponding to the electronic device 101 from the server. A text object 214-1 and the text object 414-2 may be displayed based on substantially similar log information. Likewise, the text object 214-2 and a text object 414-1 may be identified by the electronic device 101 and/or the first external electronic device 103, based on substantially similar log information.

As described above, according to one or more embodiments, the electronic device 101 and/or the first external electronic device 103 may provide a user with a game service environment that may more easily identify an interaction between the first avatar and the second avatar, by bypassing, using log information, displaying all texts included in the log information and displaying a text object representing a text, which is at least a portion of the texts.

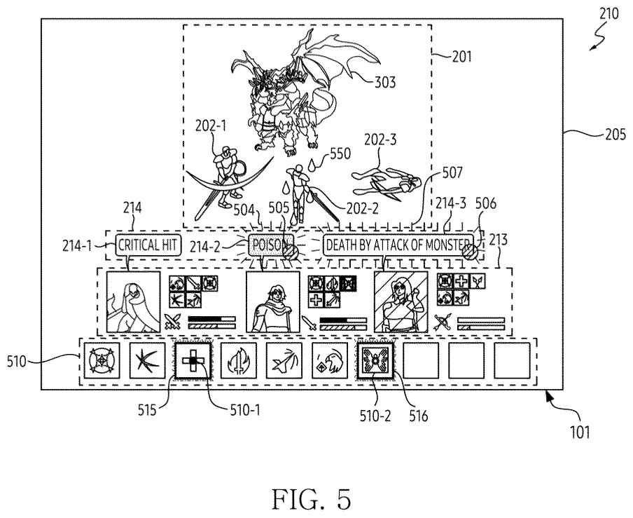

FIG. 5 illustrates an example of an operation in which an electronic device recommends a skill corresponding to a text object, in response to an input on the text object, according to one or more embodiments. An electronic device 101 of FIG. 5 may include the electronic device 101 of FIG. 1, FIG. 2, FIG. 3, and FIG. 4. According to one or more embodiments, in a state 210, the electronic device 101 may display a multimedia content 205 on a display.

For example, the electronic device 101 may display a user interface 510 including one or more icons representing one or more functions performable using a first avatar 202-1 in the multimedia content 205. For example, the electronic device 101 may receive an input 505 representing selecting a text object 214-2. For example, the electronic device 101 may display a visual effect 504 for guiding the first avatar 202-1 to be controlled based on a function corresponding to the text object 214-2 from among the one or more functions on the display together with the text object 214-2. For example, in case that a function corresponding to the text object 214-2 is included from among the one or more functions, the electronic device 101 may display the visual effect 504. The electronic device 101 may guide the input 505 on the text object 214-2 to a user by displaying the visual effect 504.

For example, the one or more functions performable by the electronic device 101 using the first avatar 202-1 may include performing one or more skills of the first avatar 202-1. The skills may include a skill (e.g., a buff skill or a debuff skill) to change a stat of another avatar distinct from the first avatar 202-1, a skill to change a stat of a virtual object 303, and/or a skill (e.g., an attack skill) to decrease an HP of the virtual object 303.

For example, the electronic device 101 may identify at least one icon 510-1 corresponding to at least one function associated with a state of a second avatar 202-2 from among the one or more functions performable using the first avatar 202-1, based on identifying the input 505 representing selecting the text object 214-2. For example, the electronic device 101 may display a visual effect 515 for emphasizing the at least one icon 510-1 on the display. For example, the visual effect 515 may include changing a color of an outline of the at least one icon 510-1. The visual effect 515 may include highlighting and displaying the outline of the at least one icon 510-1. The visual effect 515 may include changing a size of the at least one icon 510-1 to be relatively larger than a size of a plurality of icons included in the user interface 510. The visual effect 515 may include changing a color of the at least one icon 510-1. However, it is not limited to this.

For example, the electronic device 101 may display the text object 214-2 representing the state of the second avatar 202-2 on the display, based on receiving log information on the second avatar 202-2 from a server. The log information may include information on a skill 550 applied to the second avatar 202-2. The electronic device 101 may identify a skill of the first avatar 202-1 corresponding to the state of the second avatar 202-2, based on identifying the input 505 on at least a portion of the text object 214-2 (e.g., poison). The electronic device 101 may identify the skill corresponding to the state of the second avatar 202-2 from among the one or more skills of the first avatar 202-1. The electronic device 101 may use the visual effect 515 to guide the user to the at least one identified skill.

For example, the electronic device 101 may identify a plurality of skills of the first avatar 202-1 corresponding to the state of the second avatar 202-2. The electronic device 101 may recommend at least one skill of the plurality of skills, based on identifying an event occurring in an in-game screen (e.g., the in-game screen 201 of FIG. 2) through the log information. The electronic device 101 may identify at least one skill having a relatively high priority based on a relationship between the plurality of skills and the event. However, it is not limited thereto.

For example, the electronic device 101 may perform, based on an input representing selecting the at least one icon 510-1, using the first avatar 202-1, at least one function for changing the state of the second avatar 202-2. The at least one function for changing the state of the second avatar 202-2 may mean that the electronic device 101 uses a skill of the first avatar 202-1, by controlling the first avatar 202-1. The electronic device 101 may change, based on using the skill of the first avatar 202-1 by controlling the first avatar 202-1, the second avatar 202-2 from a first state (e.g., a poison state) to a second state (e.g., a normal state). For example, the electronic device 101 may receive, based on performing the at least one function, other log information distinct from the log information on the second avatar 202-2 from the server. The other log information may include information representing that the state of the second avatar 202-2 is changed to the second state. The electronic device 101 may, based on receiving the other log information, temporarily stop displaying the text object 214-2. As an example, in a case that information representing another state of the second avatar 202-2 is included in the other log information, the electronic device 101 may display another text object representing the other state. However, it is not limited thereto.

For example, the electronic device 101 may display, using log information, a text object 214-3 representing death of a third avatar 202-3 on the display. The death of the third avatar 202-3 may mean a state in which a hit point (HP) of the third avatar reaches a specified value (e.g., 0). The electronic device 101 may, based on receiving an input 506 representing selecting the text object 214-3, identify at least one function for reviving the third avatar. For example, the electronic device 101 may display a visual effect 507 for representing identification of the at least one function by overlapping the text object 214-3. The at least one function may include at least one skill usable by the first avatar 202-1. For example, the electronic device 101 may identify a skill of the first avatar 202-1 for reviving the third avatar 202-3, by controlling the first avatar 202-1. The identified skill of the first avatar 202-1 may correspond to at least one icon 510-2 in the user interface. The electronic device 101 may display a visual effect 516 corresponding to the at least one icon 510-2 by overlapping the at least one icon. For example, the at least one function for reviving the third avatar 202-3 may mean that the electronic device 101 changes the HP of the third avatar 202-3 to a value (e.g., a value greater than 0) distinct from the specified value, by controlling the first avatar 202-1 based on the skill. For example, the text object 214-3 may include information on the virtual object 303 (e.g., a monster) included in the multimedia content 205 that caused the death of the third avatar 202-3.

According to one or more embodiments, the electronic device 101 may identify a target of a skill of the first avatar 202-1 corresponding to at least one text object, based on receiving an input representing selecting the at least one text object from among text objects 214. The electronic device 101 may set an avatar matching the at least one text object as the target. The electronic device 101 may control the first avatar 202-1 to use a skill corresponding to the at least one selected text object of the first avatar 202-1 to the avatar set as the target. For example, the electronic device 101 may bypass displaying the visual effect 515 in response to the input 505 on the text object 214-2, and control the first avatar 202-1 based on a skill corresponding to the at least one icon 510-1. However, it is not limited thereto.

As described above, according to one or more embodiments, the electronic device 101 may receive an input representing selecting at least one text object from among text objects. The electronic device 101 may identify a skill corresponding to the at least one text object and/or an avatar (or a virtual object) to be a target of the skill based on receiving the input. In order to guide the skill corresponding to the at least one text object, the electronic device 101 may highlight and display the at least one icon 510-1 corresponding to the skill. The electronic device 101 may control the first avatar 202-1 based on the skill based on an input representing selecting the at least one icon 510-1. The electronic device 101 may control the first avatar 202-1 based on a skill optimized for an event generated on the in-game screen 201 by using log information.

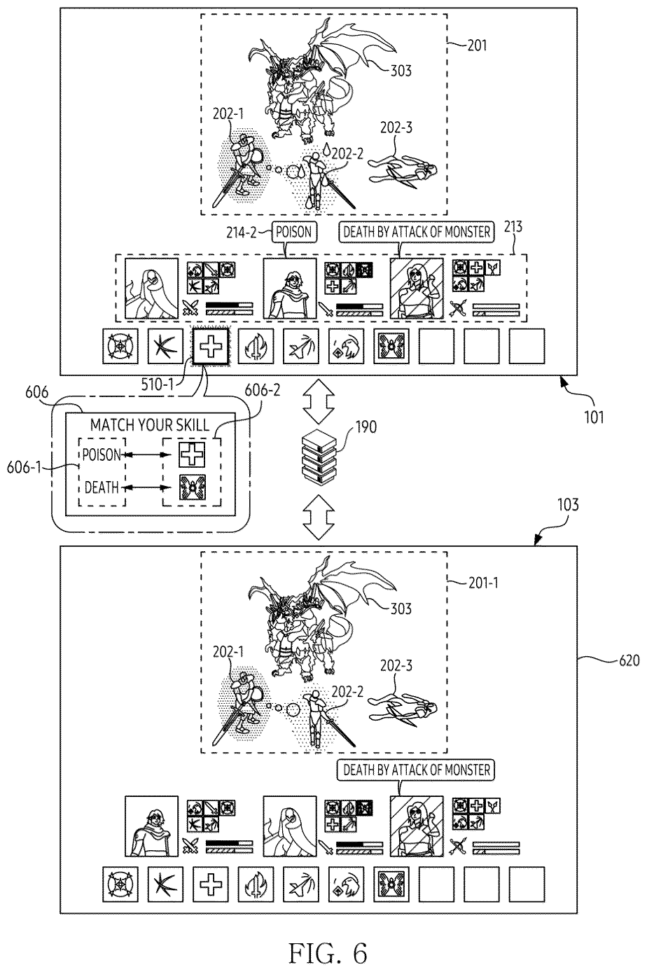

FIG. 6 illustrates an example of an operation in which an electronic device controls an avatar based on a skill corresponding to a text object, in response to an input on the text object, according to one or more embodiments. An electronic device 101 of FIG. 6 may include the electronic device 101 of FIG. 1, FIG. 2, FIG. 3, FIG. 4, and FIG. 5.

According to one or more embodiments, the electronic device 101 may display a multimedia content 205 on a display. The electronic device 101 may receive an input representing selecting a text object 214-2 corresponding to a second avatar 202-2. The electronic device 101 may identify, based on receiving the input, at least one icon 510-1. The electronic device 101 may control a first avatar 202-1, in response to another input on the at least one icon 510-1, based on a skill mapped to the text object 214-2.

For example, the electronic device 101 may control the first avatar 202-1 based on a skill set using a user interface 606 for mapping the skill corresponding to the text object 214-2. The user interface 606 may be displayed by overlapping at least a portion of the multimedia content 205. The electronic device 101 may receive an input for mapping a skill corresponding to a state of an avatar using the user interface 606. The electronic device 101 may identify, based on identifying the received input, the skill corresponding to the text object 214-2. However, it is not limited thereto. The user interface 606 may be used to map each of one or more functions (e.g., a skill) performable using the first avatar 202-1 and states of the avatar.

For example, the electronic device 101 may map, using the user interface 606, a state 606-1 and a skill 606-2 of an avatar. For example, the electronic device 101 may map, using mapping data, the state 606-1 and the skill 606-2. The electronic device 101 may map, based on a user input, the state 606-1 and the skill 606-2. The electronic device 101 may identify, using the user interface 606, a skill mapped to a state representing the text object 214-2.

For example, the electronic device 101 may transmit, to a server 190, information on using the skill to the second avatar 202-2 who is the target of the skill by controlling the first avatar 202-1. The server 190 may update, using the information, log information (e.g., the log information 132 of FIG. 1) in memory (e.g., the memory 130-1 of FIG. 1) of the server 190. The server 190 may transmit the log information 132 to the electronic device 101 and/or a plurality of external electronic devices 150. A first external electronic device 103 corresponding to the second avatar 202-2 from among the plurality of external electronic devices may display a multimedia content 620 on a display (e.g., the display 155-2 of FIG. 1) of the first external electronic device 103.

For example, the first external electronic device 103 may receive, from the server 190, log information on the first avatar 202-1 using the skill corresponding to the text object 214-2 to the second avatar 202-2. The first external electronic device 103 may change, based on receiving the log information, a state of the second avatar 202-2. The first external electronic device 103 may transmit information representing the changed state of the second avatar 202-2 to the server 190. The server 190 may update, using the information, the log information stored in the memory. The server 190 may transmit the updated log information to the electronic device 101 and/or the plurality of external electronic devices 150.

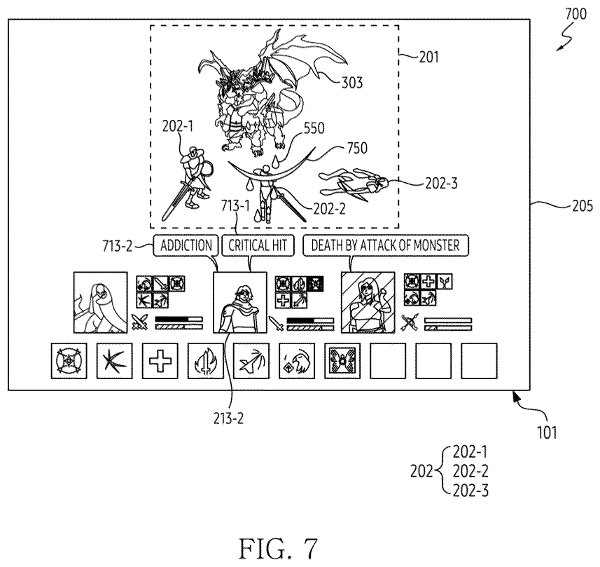

For example, the electronic device 101 may receive log information representing the changed state of the second avatar 202-2 from the server 190. The electronic device 101 may, based on receiving the log information, temporarily stop displaying the text object 214-2. However, it is not limited thereto. The electronic device 101 may display, using the log information, one or more text objects adjacent to each of visual objects 213. Referring to FIG. 7, an example of an operation in which the electronic device 101 displays, using the log information, the one or more text objects adjacent to each of the visual objects 213 will be described later.

FIG. 7 illustrates an example of a state in which an electronic device displays, using log information, a plurality of text objects representing a state of an avatar, according to one or more embodiments. An electronic device 101 of FIG. 7 may include the electronic device 101 of FIG. 1, FIG. 2, FIG. 3, FIG. 4, FIG. 5, and FIG. 6.

According to one or more embodiments, the electronic device 101 may display a multimedia content 205 on a display in a state 700. The electronic device 101 may identify an event occurring between avatars 202 and a virtual object 303 included in the multimedia content 205. The electronic device 101 may identify the event, based on receiving log information representing the event from a server.

For example, the electronic device 101 may receive log information on a second avatar 202-2 from the server. The electronic device 101 may identify, using the log information, a state of the second avatar 202-2. The electronic device 101 may display, based on identifying the state of the second avatar 202-2, text objects 713-1 and 713-2 for representing the state of the second avatar 202-2 adjacent to a visual object 213-2.

For example, the electronic device 101 may identify, using the log information, the state of the second avatar 202-2 hit from the virtual object 303. The log information may include information representing hit 750 on the second avatar 202-2. The state of the second avatar 202-2 may be identified based on an amount of a decrease in a hit point (HP) of the second avatar 202-2 that is greater than or equal to a specified threshold. As an example, the state of the second avatar 202-2 may be obtained based on identifying that the second avatar 202-2 is hit (e.g., a critical hit) by the virtual object 303 based on a specified accuracy rate. However, it is not limited thereto.

For example, based on identifying the state of the second avatar 202-2 hit from the virtual object 303, the electronic device 101 may display the text object 713-1 representing the state adjacent to the visual object 213-2. The electronic device 101 may guide a user of the electronic device 101 to the hit state of the second avatar 202-2, based on displaying the text object 713-1 adjacent to the visual object 213-2.

For example, the electronic device 101 may identify, using log information, the state of the second avatar 202-2 to which a skill 550 is applied. Based on identifying the state of the second avatar 202-2 to which the skill 550 is applied, the electronic device 101 may display the text object 713-2 (e.g., addiction) adjacent to the visual object 213-2.

For example, based on identifying an input on at least one text object from among the text objects 713-1 and 713-2, the electronic device 101 may highlight and display at least one icon (e.g., the at least one icon 510-1 of FIG. 5) corresponding to the at least one text object. The electronic device 101 may receive an input on the at least one icon. The electronic device 101 may receive the input on the at least one icon and control the first avatar 202-1 based on a skill corresponding to the at least one icon. The electronic device 101 may receive, from the server (e.g., the server 190 of FIG. 1), log information representing that the state of the second avatar 202-1 is changed by the skill. The electronic device 101 may, based on receiving the log information, temporarily refrain from displaying the at least one text object. However, it is not limited thereto.

FIG. 8 illustrates an example of a flowchart representing an operation of an electronic device, according to one or more embodiments. An electronic device 101 of FIG. 8 may include the electronic device 101 of FIG. 1, FIG. 2, FIG. 3, FIG. 4, FIG. 5, FIG. 6, and FIG. 7. At least one of operations of FIG. 8 may be performed by the electronic device 101 of FIG. 2 and/or the processor 120 of FIG. 1. Each of the operations of FIG. 8 may be performed sequentially, but is not necessarily performed sequentially. For example, an order of each of the operations may be changed, and at least two operations may be performed in parallel.

According to one or more embodiments, in an operation 810, a processor may display a multimedia content including a plurality of avatars on a display. For example, the processor may display a first avatar corresponding to an electronic device and/or a second avatar corresponding to at least one external electronic device among a plurality of external electronic devices on the display. The multimedia content may include an in-game screen including the plurality of avatars and/or a user interface for using the multimedia content. The first avatar and the second avatar may be included in at least one group (e.g., a party, or a clan).

According to one or more embodiments, in an operation 820, the processor may receive, using communication circuitry, log information on an event occurring in the multimedia content from an external electronic device (e.g., the server 190). The event may be identified based on a state of the first avatar or the second avatar, whether each of avatars is hit, whether each of the avatars attacks, a used skill, information on an attacked target, and information on a hit target. A server may share the log information occurring between the electronic device and the plurality of external electronic devices (e.g., the plurality of external electronic devices 150 of FIG. 1) based on identifying the first avatar and the second avatars included in the at least one group.

According to one or more embodiments, in an operation 830, the processor may identify, using the log information, a state of the second avatar distinct from the first avatar corresponding to the electronic device from among the plurality of avatars. For example, the processor may identify, using the log information, information on the second avatar. The information on the second avatar may include the state of the second avatar, whether the second avatar is hit, skill information used by the second avatar, whether the second avatar attacks, and/or whether the second avatar is killed.

According to one or more embodiments, in an operation 840, the processor may display, using the log information, a text object representing the state of the second avatar adjacent to a visual object corresponding to the second avatar in the multimedia content. The processor may display a user interface including one or more icons representing one or more functions performable using the first avatar in the multimedia content. The one or more functions performable using the first avatar may include a skill that may be used in the multimedia content by controlling the first avatar. Each of the one or more icons may correspond to each of skills of the first avatar. Based on receiving an input representing selecting the text object, the processor may identify at least one icon corresponding to at least one function associated with the state of the second avatar from among the one or more functions. For example, the processor may display, on the display, a visual effect for highlighting the at least one icon. Based on displaying the visual effect for highlighting the at least one icon, the processor may guide the user to feedback for changing the state of the second avatar by controlling the first avatar.

As described above, in an electronic device according to one or more embodiments, the electronic device may comprise a display, memory, communication circuitry, and a processor. The processor may be configured to display, on the display, a multimedia content including a plurality of avatars. The processor may be configured to receive, using the communication circuitry, from an external electronic device, log information on an event occurring in the multimedia content. The processor may be configured to identify, using the log information, a state of a second avatar distinct from a first avatar corresponding to the electronic device from among the plurality of avatars. The processor may be configured to display, using the log information, a text object representing the state of the second avatar, adjacent to a visual object corresponding to the second avatar in the multimedia content.

For example, the processor may be configured to display a user interface including one or more icons representing one or more functions performable using the first avatar in the multimedia content. The processor may be configured to, based on receiving an input representing selecting the text object, identify at least one icon corresponding to at least one function associated with the state of the second avatar from among the one or more functions. The processor may be configured to display, on the display, a visual effect for highlighting the at least one icon.

For example, the processor may be configured to perform, in response to another input representing selecting the at least one icon, using the first avatar, the at least one function for changing the state of the second avatar. The processor may be configured to, based on performing the at least one function, receive other log information distinct from the log information on the second avatar from the external electronic device. The processor may be configured to, based on receiving the other log information, temporarily stop displaying the text object.

For example, the processor may be configured to, in response to the other input, based on performing the at least one function by targeting the second avatar using the first avatar, change the state of the second avatar to another state. The processor may be configured to, based on receiving the other log information representing the another state, temporarily stop displaying the text object.

For example, the processor may be configured to display, on the display, with the text object, another visual effect representing that at least one function associated with the state of the second avatar from among the one or more functions is included.

For example, the processor may be configured to display, based on the visual effect, the at least one icon having a size larger than a size of other icons corresponding to the one or more functions.

For example, the processor may be configured to perform, in response to an input on the text object, at least one function for changing the state of the second avatar to another state by controlling the first avatar. The processor may be configured to, based on performing the at least one function, receive, from the external electronic device, other log information distinct from the log information on the second avatar. The processor may be configured to, based on receiving the other log information, temporarily stop displaying the text object.

For example, for displaying a multimedia content including the plurality of avatars, the processor may be configured to identify a relationship between the plurality of avatars included in at least one group. The processor may be configured to, based on identifying the relationship between the plurality of avatars, receive, from the external electronic device, avatar information of the second avatar corresponding to another external electronic device distinct from the external electronic device. The processor may be configured to, based on receiving the avatar information from the external electronic device, display, on the display, the visual object corresponding to the second avatar.

For example, the processor may be configured to, based on identifying the state of the second avatar, identify the at least one function configured using another user interface for mapping each of a plurality of states including the state and the one or more functions.

For example, the processor may be configured to, based on receiving the log information, bypass displaying a text representing the log information and display the text object using a specified word representing the state of the second avatar in the text.

As described above, in a method performed by an electronic device according to one or more embodiments, the method may comprise displaying, on a display, a multimedia content including a plurality of avatars. The method may comprise receiving, using communication circuitry, from an external electronic device, log information on an event occurring in the multimedia content. The method may comprise identifying, using the log information, a state of a second avatar distinct from a first avatar corresponding to the electronic device from among the plurality of avatars. The method may comprise displaying, using the log information, a text object representing the state of the second avatar, adjacent to a visual object corresponding to the second avatar in the multimedia content.

For example, the method may comprise displaying a user interface including one or more icons representing one or more functions performable using the first avatar in the multimedia content. The method may comprise, based on receiving an input representing selecting the text object, identifying at least one icon corresponding to at least one function associated with the state of the second avatar from among the one or more functions. The method may comprise displaying, on the display, a visual effect for highlighting the at least one icon.

For example, the method may comprise performing, in response to another input representing selecting the at least one icon, using the first avatar, the at least one function for changing the state of the second avatar. The method may comprise, based on performing the at least one function, receiving other log information distinct from the log information on the second avatar from the external electronic device. The method may comprise, based on receiving the other log information, temporarily stopping displaying the text object.

For example, the method may comprise, in response to the other input, based on performing the at least one function by targeting the second avatar using the first avatar, changing the state of the second avatar to another state. The method may comprise, based on receiving the other log information representing the another state, temporarily stopping displaying the text object.

For example, the method may comprise displaying, on the display, with the text object, another visual effect representing that at least one function associated with the state of the second avatar from among the one or more functions is included.

For example, the method may comprise displaying, based on the visual effect, the at least one icon having a size larger than a size of other icons corresponding to the one or more functions.

For example, the method may comprise performing, in response to an input on the text object, at least one function for changing the state of the second avatar to another state by controlling the first avatar. The method may comprise, based on performing the at least one function, receiving, from the external electronic device, other log information distinct from the log information on the second avatar. The method may comprise, based on receiving the other log information, temporarily stopping displaying the text object.

For example, the method may comprise, based on receiving the log information, bypassing displaying a text representing the log information and displaying the text object using a specified word representing the state of the second avatar in the text.

For example, the method may comprise, based on identifying the state of the second avatar, identifying the at least one function configured using another user interface for mapping each of a plurality of states including the state and the one or more functions.

As described above, in a computer-readable storage medium storing one or more programs according to one or more embodiments, the one or more programs may be configured to, when executed by a processor of an electronic device, on a display, a multimedia content including a plurality of avatars. The one or more programs may be configured to, when executed by the processor of the electronic device, cause the electronic device to receive, using communication circuitry, from an external electronic device, log information on an event occurring in the multimedia content. The one or more programs may be configured to, when executed by the processor of the electronic device, cause the electronic device to identify, using the log information, a state of a second avatar distinct from a first avatar corresponding to the electronic device from among the plurality of avatars. The one or more programs may be configured to, when executed by the processor of the electronic device, cause the electronic device to display, using the log information, a text object representing the state of the second avatar, adjacent to a visual object corresponding to the second avatar in the multimedia content.

For example, the one or more programs may be configured to, when executed by the processor of the electronic device, cause the electronic device to display a user interface including one or more icons representing one or more functions performable using the first avatar in the multimedia content. The one or more programs may be configured to, when executed by the processor of the electronic device, cause the electronic device to, based on receiving an input representing selecting the text object, identify at least one icon corresponding to at least one function associated with the state of the second avatar from among the one or more functions. The one or more programs may be configured to, when executed by the processor of the electronic device, cause the electronic device to display, on the display, a visual effect for highlighting the at least one icon.

For example, the one or more programs may be configured to, when executed by the processor of the electronic device, cause the electronic device to perform, based on another input representing selecting the at least one icon, using the first avatar, the at least one function for changing the state of the second avatar. The one or more programs may be configured to, when executed by the processor of the electronic device, cause the electronic device to, based on performing the at least one function, receive other log information distinct from the log information on the second avatar from the external electronic device. The one or more programs may be configured to, when executed by the processor of the electronic device, cause the electronic device to, based on receiving the other log information, temporarily stop displaying the text object.

For example, the one or more programs may be configured to, when executed by the processor of the electronic device, cause the electronic device to, in response to the other input, based on performing the at least one function by targeting the second avatar using the first avatar, change the state of the second avatar to another state. The one or more programs may be configured to, when executed by the processor of the electronic device, cause the electronic device to, based on receiving the other log information representing the another state, temporarily stop displaying the text object.

For example, the one or more programs may be configured to, when executed by the processor of the electronic device, cause the electronic device to display, on the display, with the text object, another visual effect representing that at least one function associated with the state of the second avatar from among the one or more functions is included.

For example, the one or more programs may be configured to, when executed by the processor of the electronic device, cause the electronic device to, based on identifying the state of the second avatar, identify the at least one function configured using another user interface for mapping each of a plurality of states including the state and the one or more functions.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device comprising:
a display;
memory;
communication circuitry; and
a processor;
wherein the processor is configured to:
display, on the display, a multimedia content including a plurality of avatars;
receive, using the communication circuitry, from an external electronic device, log information indicating an event occurring in the multimedia content;
identify, using the log information and from among the plurality of avatars, a state of a second avatar that is distinct from a first avatar corresponding to the electronic device; and
display, on the display and using the log information, a text object representing the state of the second avatar, adjacent to a visual object corresponding to the second avatar in the multimedia content.

2. The electronic device of claim 1, wherein the processor is further configured to:
display a user interface including one or more icons representing one or more functions performable using the first avatar in the multimedia content;
based on receiving an input representing selecting the text object and from among the one or more functions, identify at least one icon corresponding to at least one function associated with the state of the second avatar; and
display, on the display, a visual effect highlighting the at least one icon.

3. The electronic device of claim 2, wherein the processor is further configured to:
perform, using the first avatar and in response to another input indicating a selection of the at least one icon, the at least one function as indicating to change the state of the second avatar;
based on performing the at least one function, receive, from the external electronic device, other log information, distinct from the log information, indicating the second avatar ; and
based on receiving the other log information, stop displaying the text object.

4. The electronic device of claim 2, wherein the processor is further configured to:
display, on the display and with the text object, another visual effect indicating that the at least one function, from among the one or more functions, as associated with the state of the second avatar is included.

5. The electronic device of claim 2, wherein the processor is further configured to:
based on identifying the state of the second avatar, identify the at least one function as configured by another user interface and mapping each of a plurality of states, including the state of the second avatar, and the one or more functions.

6. The electronic device of claim 1, wherein the processor is further configured to:
based on receiving the log information, bypass displaying a text representing the log information by instead displaying the text object as a specified word representing the state of the second avatar.

7. The electronic device of claim 1, wherein the processor is further configured to:
perform, by controlling the first avatar and in response to an input indicating the text object, at least one function of changing the state of the second avatar to another state;
based on performing the at least one function, receive, from the external electronic device, other log information, distinct from the log information, indicating the second avatar; and
based on receiving the other log information, stop displaying the text object.

8. The electronic device of claim 1, wherein the processor is further configured to:
identify a relationship between the plurality of avatars included in at least one group;
based on identifying the relationship between the plurality of avatars, receive, from the external electronic device, avatar information of the second avatar as corresponding to another external electronic device distinct from the external electronic device; and
based on receiving the avatar information from the external electronic device, display, on the display, the visual object corresponding to the second avatar in the multimedia content.

9. A method performed by an electronic device, the method comprising:
displaying, on a display, a multimedia content including a plurality of avatars;
receiving, using communication circuitry, from an external electronic device, log information indicating an event occurring in the multimedia content;
identifying, using the log information and from among the plurality of avatars, a state of a second avatar that is distinct from a first avatar corresponding to the electronic device; and
displaying, on the display and using the log information, a text object representing the state of the second avatar, adjacent to a visual object corresponding to the second avatar in the multimedia content.

10. The method of claim 9, further comprising:
displaying a user interface including one or more icons representing one or more functions performable using the first avatar in the multimedia content;
based on receiving an input representing selecting the text object and from among the one or more functions, identifying at least one icon corresponding to at least one function associated with the state of the second avatar; and
displaying, on the display, a visual effect highlighting the at least one icon.

11. The method of claim 10, further comprising:
performing, using the first avatar and in response to another input indicating a selection of the at least one icon, the at least one function as indicating to change the state of the second avatar;
based on performing the at least one function, receiving, from the external electronic device, other log information, distinct from the log information, indicating the second avatar; and
based on receiving the other log information, stopping displaying the text object.

12. The method of claim 10, further comprising:
displaying, on the display and with the text object, another visual effect indicating that the at least one function, from among the one or more functions, as associated with the state of the second avatar is included.

13. The method of claim 10, further comprising:
based on identifying the state of the second avatar, identifying the at least one function as configured by another user interface and mapping each of a plurality of states, including the state of the second avatar, and the one or more functions.

14. The method of claim 10, further comprising:
based on receiving the log information, bypassing displaying a text representing the log information by instead displaying the text object as a specified word representing the state of the second avatar.

15. The method of claim 9, further comprising:
performing, by controlling the first avatar and in response to an input indicating the text object, at least one function of changing the state of the second avatar to another state;
based on performing the at least one function, receiving, from the external electronic device, other log information, distinct from the log information, indicating the second avatar; and
based on receiving the other log information, stopping displaying the text object.

16. A non-transitory computer-readable storage medium storing one or more programs, wherein the one or more programs are configured to, when executed by a processor of an electronic device with a display, memory, and communication circuitry, cause the electronic device to:
display, on the display, a multimedia content including a plurality of avatars;
receive, using the communication circuitry, from an external electronic device, log information indicating an event occurring in the multimedia content;
identify, using the log information and from among the plurality of avatars, a state of a second avatar that is distinct from a first avatar corresponding to the electronic device; and
display, on the display and using the log information, a text object representing the state of the second avatar, adjacent to a visual object corresponding to the second avatar in the multimedia content.

17. The non-transitory computer-readable storage medium of claim 16, wherein the one or more programs are further configured to, when executed by the processor of the electronic device, cause the electronic device to:
display a user interface including one or more icons representing one or more functions performable using the first avatar in the multimedia content;
based on receiving an input representing selecting the text object and from among the one or more functions, identify at least one icon corresponding to at least one function associated with the state of the second avatar; and
display, on the display, a visual effect highlighting the at least one icon.

18. The non-transitory computer-readable storage medium of claim 17, wherein the one or more programs are further configured to, when executed by the processor of the electronic device, cause the electronic device to:
perform, using the first avatar and based on another input indicating a selection of the at least one icon, the at least one function as indicating to change the state of the second avatar;
based on performing the at least one function, receive, from the external electronic device, other log information, distinct from the log information, indicating the second avatar ; and
based on receiving the other log information, temporarily stop displaying the text object.

19. The non-transitory computer-readable storage medium of claim 17, wherein the one or more programs are further configured to, when executed by the processor of the electronic device, cause the electronic device to:
display, on the display and with the text object, another visual effect indicating that the at least one function, from among the one or more functions, as associated with the state of the second avatar is included.

20. The non-transitory computer-readable storage medium of claim 17, wherein the one or more programs are further configured to, when executed by the processor of the electronic device, cause the electronic device to:
based on identifying the state of the second avatar, identify the at least one function as configured by another user interface and mapping each of a plurality of states, including the state of the second avatar, and the one or more functions.
